(19) United States
(12) Patent Application Publication
(10) Pub. No.: US 2015/0254863 A1
(43) Pub. Date: Sep. 10, 2015

(54) METHOD OF DETECTING EXCESSIVE DISPARITY OBJECT

(71) Applicants: Youngsan University Industry Academy Cooperation Foundation, Gyeongsangnam-do (KR); Busan IT Industry Promotion Agency, Busan (KR)

(72) Inventors: Sanghyun Kim, Busan (KR); Gilja So, Busan (KR); Jeongyeop Kim, Busan (KR)

(73) Assignee: Youngsan University Industry Academy Cooperation Foundation, Gyeongsangnam-do (KR)

(21) Appl. No.: 14/389,777

(22) PCT Filed: Dec. 3, 2013
(86) PCT No.: PCT/KR2013/011102

§ 371 Date: Oct. 1, 2014

(30) Foreign Application Priority Data
Nov. 29, 2013 (KR) 1020130147221

(51) Int. Cl. G06T 7/00

(52) U.S. Cl. CPC G06T 7/0075; G06T 2200/04; G06T 2207/10012; G06T 2207/10028; G06T 2207/20228

(57) ABSTRACT

Disclosed is a method of detecting an excessive disparity object, which separates and detects only an object having an excessive disparity. The method includes a disparity-map forming step of forming disparity-maps for left and right images by analyzing the left and right images included in a 3-D image, a binarization step of setting an excessive disparity candidate region having a disparity value equal to or greater than a preset threshold value in each disparity-map, a masking step of maintaining a pixel value of a region of one selected from the left and right images, which is overlapped with the excessive disparity candidate region, as an original pixel value, and substituting a pixel value of a region of the one selected from the left and right images, which is not overlapped with the excessive disparity candidate region, with a reference pixel value, and a region division step of performing region division with respect to the region having the maintained pixel value based on pixel brightness and disparity.

### TECHNICAL FIELD

The present inventions relates to a method of detecting an excessive disparity object, and more particularly to a method of separating and detecting an object having an excessive disparity from a 3-D image.

### BACKGROUND ART

Recently, the demand for 3-D images has been significantly rapidly increased, and various patents and papers have been made on methods of generating and processing the 3-D images. A typical 3-D image is made by simultaneously obtaining left and right images from two cameras arranged in a horizontal direction and allowing the left and right images to be input into left and right eyes of a viewer. The viewer synthesizes the left and right images input through the left and right eyes of the viewer, respectively, and recognizes the sense of depth. According to the scheme, the uniformity of the left and right images must be first ensured for the purpose of safe and comfortable viewing the images.

According to typical 3-D stereo matching schemes, the relation between corresponding pixel pairs of left and right images is utilized to calculate the disparity or the depth information. In addition, according to the schemes, after finding depth information of all pixels contained in an image through interpolation, the depth information is re-organized on a 3-D plane, that is, in a disparity-map.

Meanwhile, the endurance in safe and convenient viewing for 3-D images by a viewer is significantly important. In particular, the safety and convenient viewing for the 3-D images is very important to children who are not yet completely grown in a visual system and have a distance between eyebrows shorter than those of adults. Therefore, in order to prevent the additional eye fatigue of the children, it is necessary to reduce the excessive sense of depth of the 3-D image, that is, the excessive disparity in a disparity-map when producing images.

In a Yuan scheme, the inconvenience and the fatigue are caused in the 3-D images due to the error in recognition of the depth information resulting from excessive positive and negative disparities in a Z axis direction, that is, the direction perpendicular to a screen image. In addition, the error in the recognition of the depth information is corrected by examining disparity values, detecting an excessive disparity, and employing depth tuning schemes including a depth shift scheme and a depth scaling scheme. If specific disparity values are greater than a preset threshold value in a histogram, the disparity values are regarded as excessive disparities and corrected through the depth tuning scheme.

Schemes of detecting an excessive disparity based on the histogram have several problems. The excessive disparity in the 3-D image partially occurs in the unit of a region due to a specific object. However, if several objects repeatedly exist at the same depth, the objects may not be exactly extracted only by using a histogram. Many small regions are made due to the inaccuracy of the scheme of detecting the disparity or noise in the determination based on the threshold value in the histogram, so that the object may not be exactly extracted. Therefore, there is required a scheme of extracting an object (that is, an object having an excessive disparity) in the unit of a region by using both of the depth information in the disparity-map and the brightness information of left and right images.

Meanwhile, there are provided region-based and edge-based image processing schemes to extract an object in the unit of a region among image processing schemes. The region-based image processing scheme, which has been most extensively utilized, is a centroid linkage region growing (CLRG) scheme. According to the CLRG scheme, an image is scanned in the sequence of raster scan lines and regions are merged into each other if neighboring pixels of the regions have similar brightness, so that the regions are enlarged. In other words, the regions are merged by employing the brightness homogeneity between neighboring regions in a cost function. However, if the scheme is directly applied to the 3-D image, brightness comparison is sequentially performed along a scan line. In this case, if neighboring objects have similar brightness values at the boundary therebetween, the two objects may be merged into each other to be determined as one object although the two objects are determined as objects different from each other through the naked eyes of a viewer.

Therefore, a new scheme of separating and detecting only an excessive disparity object from a 3-D image must be developed.

### DISCLOSURE

### Technical Problem

The present invention is made keeping in mind the above problem occurring in the related art, and an object of the present invention is to provide a method of detecting an excessive disparity object, capable of separating and detecting only an object having an excessive disparity.

### Technical Solution

According to the present invention, there is provided a method of detecting an excessive disparity object, which includes a disparity-map forming step of forming disparity-maps for left and right images by analyzing the left and right images included in a 3-D image, a binarization step of setting an excessive disparity candidate region having a disparity value equal to or greater than a preset threshold value in each disparity-map, a masking step of maintaining a pixel value of a region of one selected from the left and right images, which is overlapped with the excessive disparity candidate region, as an original pixel value, and substituting a pixel value of a region of the one selected from the left and right images, which is not overlapped with the excessive disparity candidate region, with a reference pixel value, and a region division step of performing region division with respect to the region having the maintained pixel value based on pixel brightness and disparity.

Preferably, in the region division step, the region division is performed through a centroid linkage region growing (CLRG) scheme.

### Advantageous Effects

As described above, according to the present invention, even if objects having disparities different from each other are overlapped with each other in a 3-D image, only an object having an excessive disparity can be separated and detected from the 3-D image.

### DESCRIPTION OF DRAWINGS

FIG. 1 is a flowchart showing a method of detecting an excessive disparity object according to one embodiment of the present invention.

FIG. 2 is a view showing a 3-D experiment image to test the method of detecting the excessive disparity object according to the present embodiment.

FIG. 3 is a view showing a disparity-map of the 3-D experiment image shown in FIG. 2.

FIG. 4 is a histogram for the disparity-map.

FIG. 5 is a binarization view for the disparity-map shown in FIG. 3.

FIG. 6 is a view to explain a CLRG scheme.

FIG. 7 is a view showing an image obtained by applying the CLRG scheme to a left image of the 3-D experiment image shown in FIG. 2.

FIG. 8 is a view showing a result of region division only based on brightness of a pixel.

FIG. 9 is a view showing a result of region division based on brightness and disparity of a pixel according to one embodiment of the present invention.

FIG. 10 is a view showing a detected excessive disparity object in the 3-D image according to one embodiment of the present invention.

### BEST MODE

A method of detecting an excessive disparity object includes a disparity-map forming step of forming disparity-maps for left and right images by analyzing the left and right images included in a 3-D image, a binarization step of setting an excessive disparity candidate region having a disparity value equal to or greater than a preset threshold value in each disparity-map, a masking step of maintaining a pixel value of a region of one selected from the left and right images, which is overlapped with the excessive disparity candidate region, as an original pixel value, and substituting a pixel value of a region of the one selected from the left and right images, which is not overlapped with the excessive disparity candidate region, with a reference pixel value, and a region division step of performing region division with respect to the region having the maintained pixel value based on pixel brightness and disparity.

### Mode for Invention

Hereinafter, a method of detecting an excessive disparity object according to an exemplary embodiment of the present invention will be described with reference to accompanying drawings.

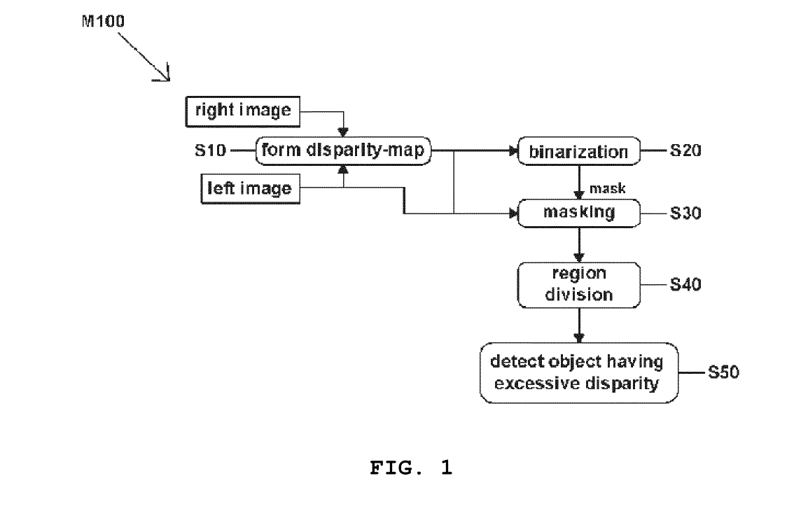

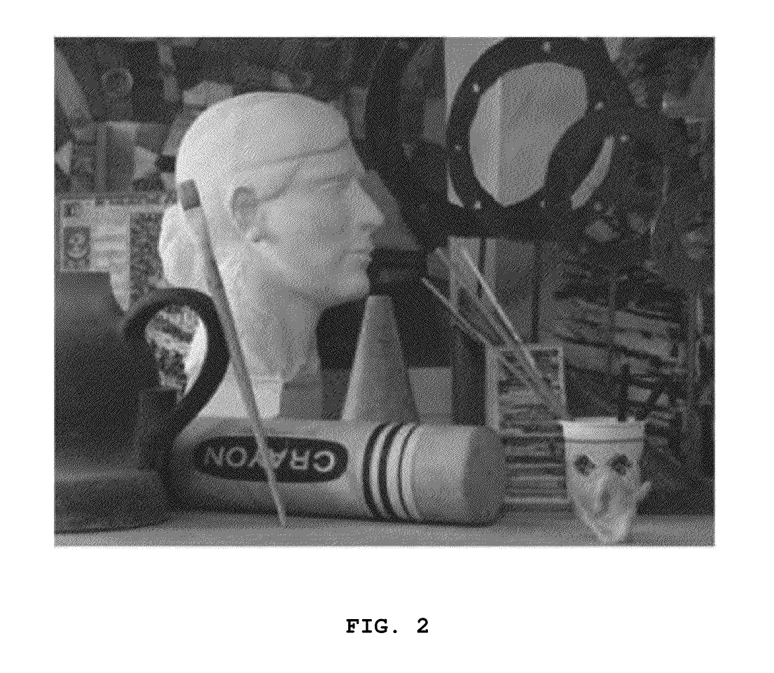

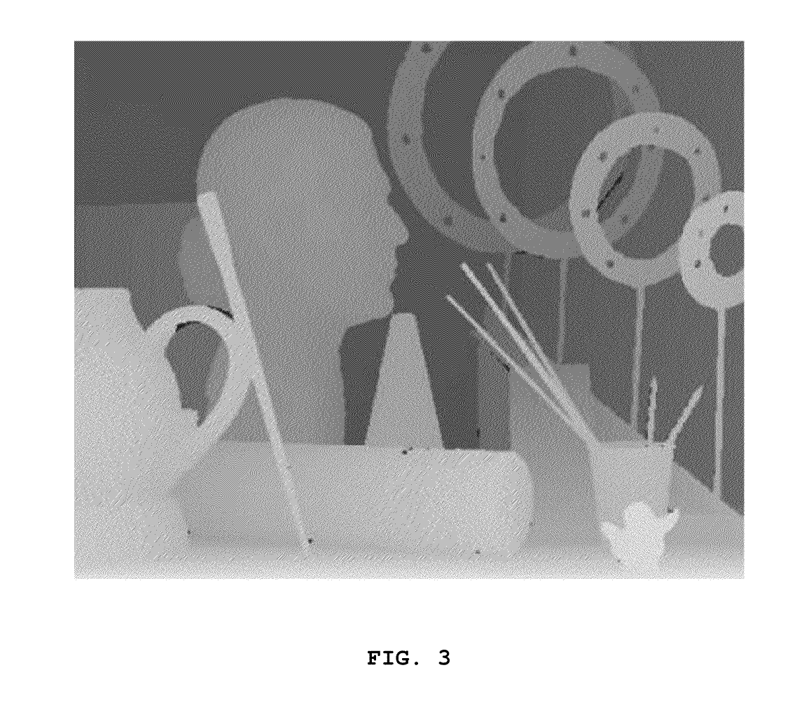

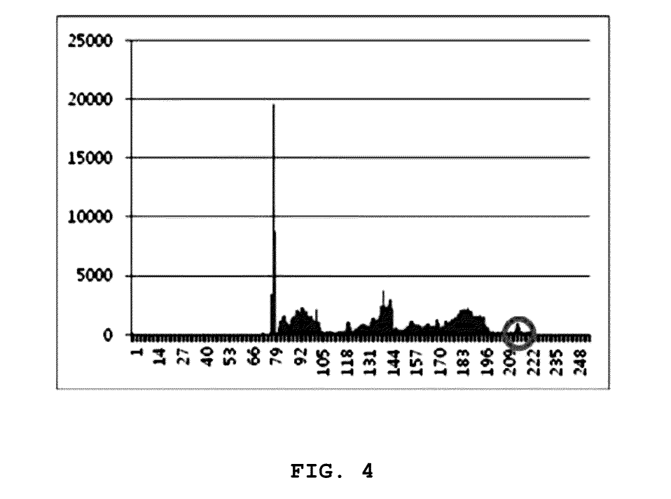

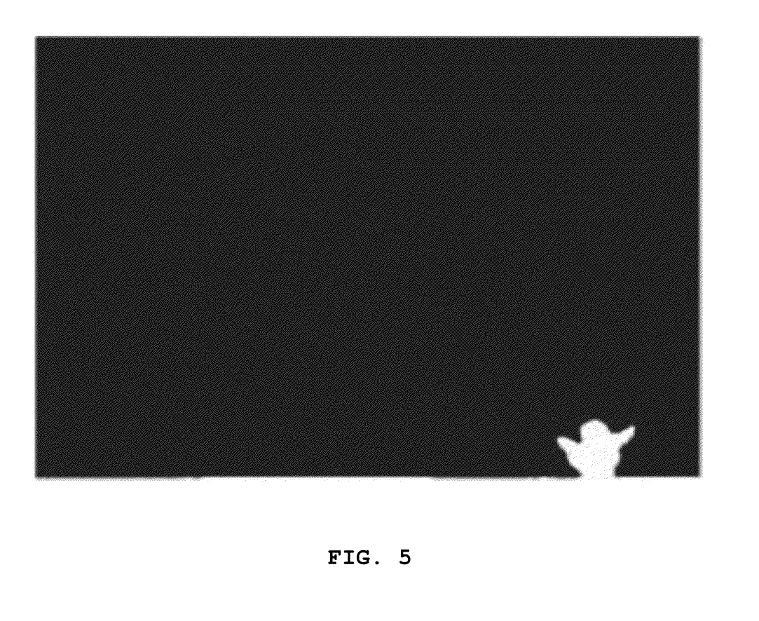

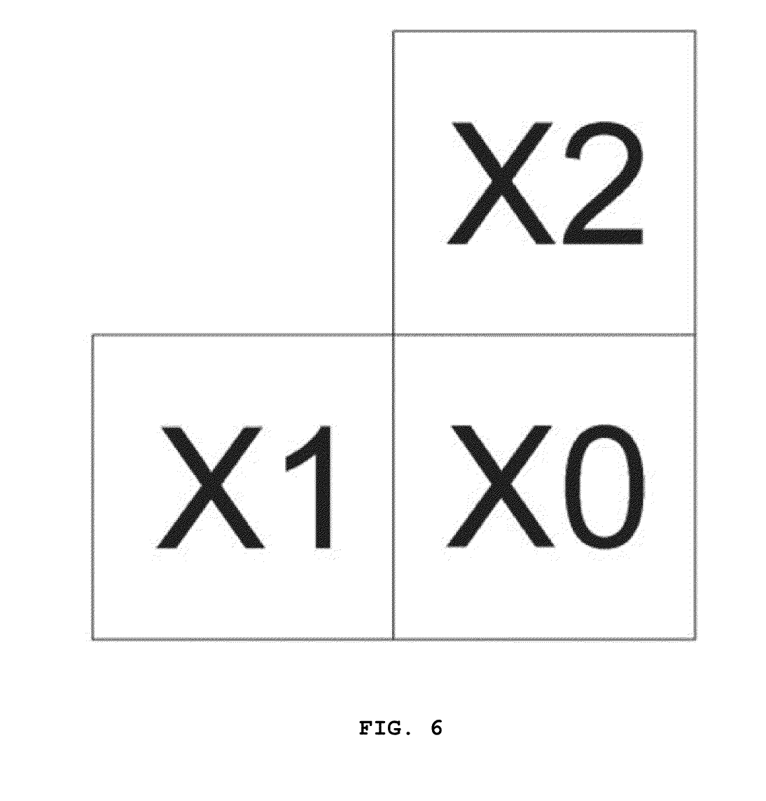

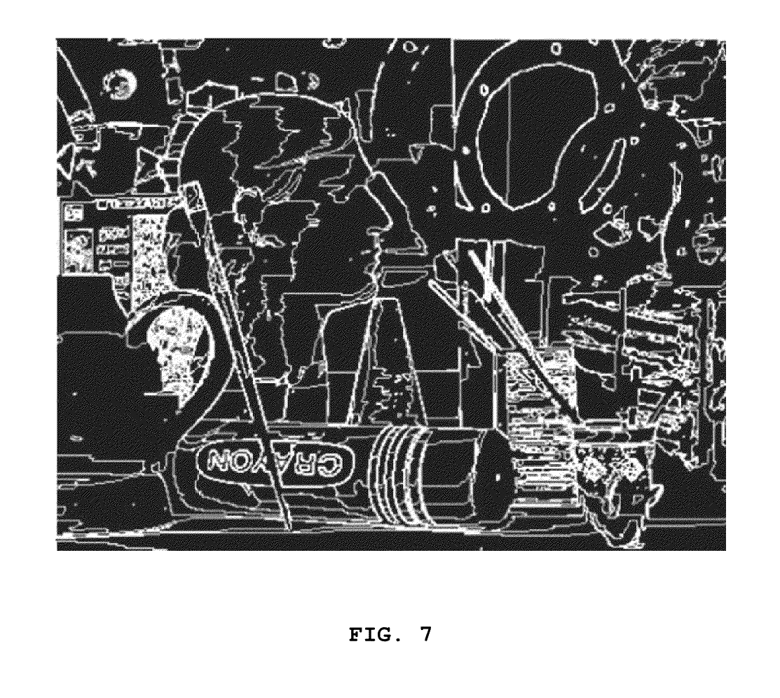

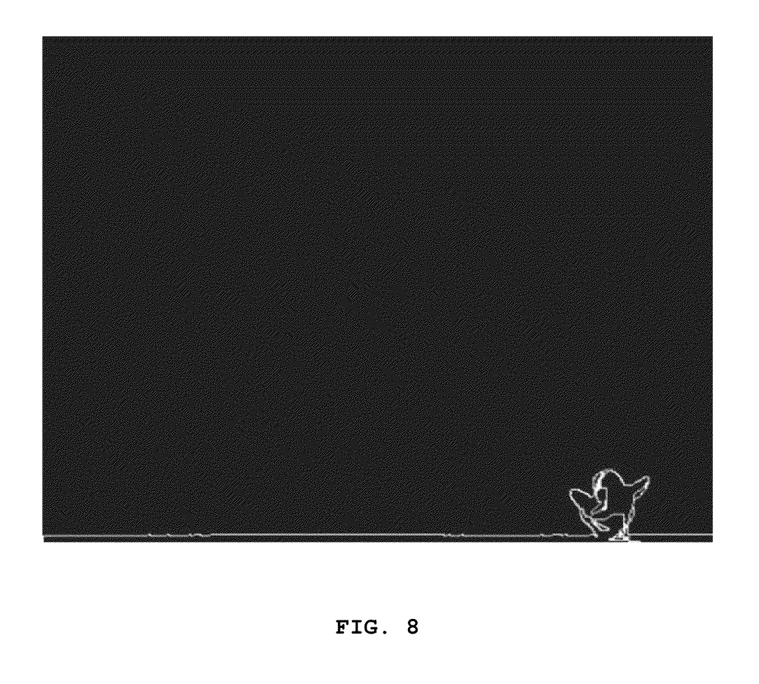

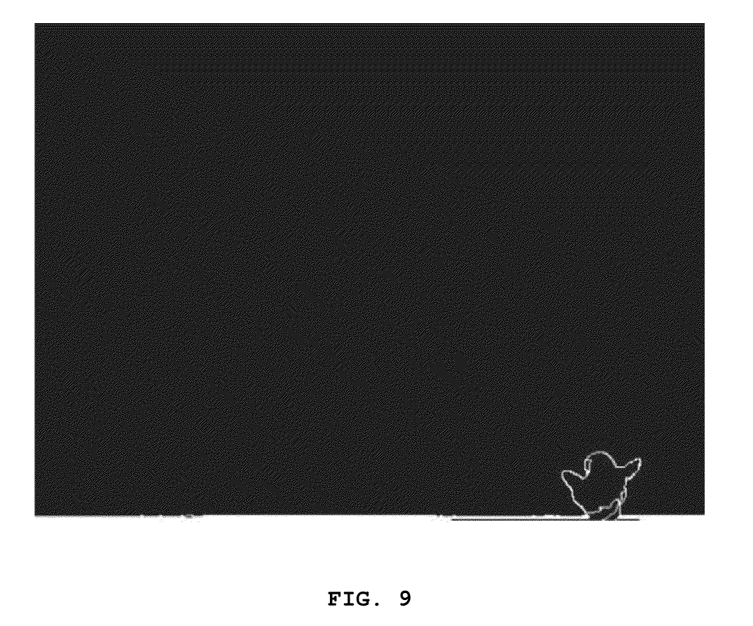

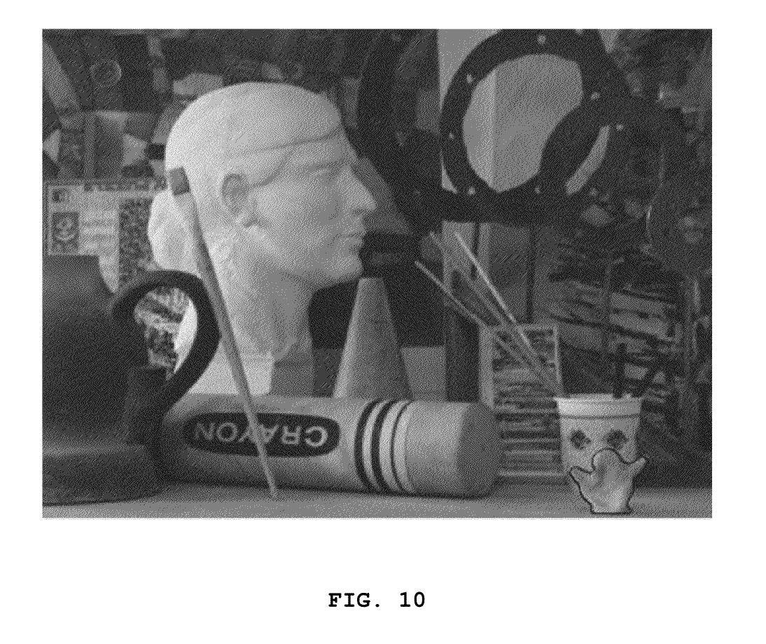

FIG. 1 is a flowchart showing a method of detecting an excessive disparity object according to one embodiment of the present invention. FIG. 2 is a view showing a 3-D experiment image to test the method of detecting the excessive disparity object according to the present embodiment. FIG. 3 is a view showing a disparity-map of the 3-D experiment image shown in FIG. 2. FIG. 4 is a histogram for the disparity-map. FIG. 5 is a binarization view for the disparity-map shown in FIG. 3. FIG. 6 is a view to explain a CLRG scheme. FIG. 7 is a view showing an image obtained by applying the CLRG scheme to a left image of the 3-D experiment image shown in FIG. 2. FIG. 8 is a view showing a result of region division only based on brightness of a pixel. FIG. 9 is a view showing a result of region division based on brightness and disparity of a pixel according to one embodiment of the present invention. FIG. 10 is a view showing a detected excessive disparity object in the 3-D image according to one embodiment of the present invention.

Referring to FIGS. 1 to 10, a method M100 of detecting an excessive disparity object according to the present embodiment includes disparity-map forming step S10, binarization step S20, masking step S30, and region division step S40.

According to the disparity-map forming step S10, a disparity is calculated by analyzing left and right images contained in a 3-D image (for example, through a normalized block matching scheme) and a disparity-map is formed based on the disparity. For example, if the disparity-map is formed from a 3-D experiment image shown in FIG. 2, the disparity-map shown in FIG. 3 may be obtained. For reference, as shown in FIG. 3, the greatest disparity may be represented at a leaf-shape prop (hereinafter, a prop) positioned at a lower right portion of an image and an edge of a table having the prop placed thereon. In addition, since a scheme of forming the disparity-map is generally known to those skilled in the art, the details thereof will be omitted.

According to the binarization step S20, a region having a disparity value that is equal to or greater than a threshold value is separated from the disparity-map, and set as an excessive disparity candidate region. In detail, if the disparity-map is realized in the form of a histogram, a result shown in FIG. 4 may be obtained. In this case, a region having an excessively great disparity value as compared with other regions, that is, a region expressed in a red circle of FIG. 4 represents the prop and the edge of the table on which the prop is placed. In addition, on the assumption that a threshold value (TH), which is arbitrarily set by a user, is about 200, regions exceeding the threshold value of 200, that is, the prop and the edge of the table are set as excessive disparity candidate regions. In addition, as shown in FIG. 5, through the above binarization, the excessive disparity candidate regions are expressed in a white color, and remaining regions are expressed in a black color.

Meanwhile, in the binarization state, the disparity candidate regions include the prop and the edge of the table. In this case, depth tuning is possible with respect to the entire portion of the prop since the entire portion of the prop is contained in the excessive disparity candidate regions. However, in the case of the edge of the table, since only the edge of the table is included in the excessive disparity candidate regions, the depth tuning is difficult only for this region (the edge of the table). Accordingly, as described below, a process of separating the regions (objects) from each other is required.

Hereinafter, a reason for performing the masking step (S30) will be described before the masking step (S30) is performed. FIG. 7 is an image obtained by applying a centroid linkage region growing (CLRG) scheme to a 3-D experiment image shown in FIG. 2. Referring to FIG. 7, if the CLRG scheme is applied to the whole image, a background or other objects are mutually merged with each other in a direction in which a scan line is progressed. Although the difference in brightness between objects is made actually, the merge of regions allows the regions to have average brightness to make it difficult to exactly extract a specific object. Therefore, in order to extract the specific object through region division, a region of interest (ROI) must be previously designated to minimize the range of the region division, and evaluation criteria for the likelihood of a cost function must be strictly applied in order to perform the region division. Therefore, according to the present invention, the masking step to designate the ROI is performed.

In the masking step S30, one of left and right images is selected, and the selected image is matched with a binarized image. For example, according to the present invention, the left image may be matched with the binarized image. Further, in the matching state, pixel values of a region of the left image overlapped with the excessive disparity candidate region (that is, a white region of FIG. 5) are maintained as original values thereof, and pixel values of a region of the left image that is not overlapped with the excessive disparity candidate region are substituted with reference pixel values, for example zeros. For reference, the reference pixel values may be randomly set by the user. However, preferably, the reference pixel values are set as values making great differences from pixel values of the region overlapped with the excessive disparity candidate region. This is required to prevent the remaining regions from being overlapped with the excessive disparity candidate region in the region division step to be described later.

In the region division step S40, the masked left image is subject to the region division through the CLRG scheme.

The CLRG scheme is one of region division schemes which have been most extensively used. Hereinafter, a typical CLGR scheme will be described in detail with reference to FIG. 6. The image is scanned in the sequence of raster scan lines. If a pixel X0 comes during the scanning process, the brightness of a neighboring pixel X2 in a Y axis and the brightness of a neighboring pixel X1 in an X axis are compared with the brightness of a present pixel, respectively. The brightness of the pixels X1 and X2 may be original brightness values of the pixels, or average brightness of a previous region if the pixels are previously included in the region. In addition, if the brightness of the pixel X0 is sufficiently similar to the brightness of a neighboring region, a preset pixel is merged with the region, a new region is allocated to the pixel X0. Then, the above process is repeatedly applied to all pixels in an image. For reference, the region division is performed by taking into consideration only the brightness of the pixel, and a cost function C′(m, n) is expressed as a following equation.

$${c}^{′} ( m , n ) = {[ {( \frac{{S}_{k}}{{Size}_{k}} - I ( m , n ) )}^{2} ]}^{0.5}$$

In the above equation, (m, n) represents coordinates of a pixel, Sₖ represents the sum of pixel values in a k^{th} region, Sizeₖ represents the size of the k^{th} region, and I(m, n) represents pixel brightness at the coordinates (m, n). In addition, pixels in which calculated values of the cost function C′(m, n) are similar to each other as described above are merged into one region.

The result of the region division of the left image only based on pixel brightness is shown in FIG. 8. Referring to FIG. 8, since the pixel values of the region of the left image that is not overlapped with the excessive disparity candidate region are substituted with the same reference pixel value, only one region (a region in black color) is represented. Meanwhile, regarding the region overlapped with the excessive disparity candidate region, although the leaf-shaped prop is divided into several regions, the edge of the table is regarded as one region. Accordingly, it is difficult to separate the leaf-shaped prop from the edge of the table through a post treatment process such as a process of removing a small region. In addition, when the region division is performed with respect to a 3-D image by taking into consideration only the pixel brightness similar to that of the related art, limitation is made in region division for each object.

In order to solve the above problem, the present invention suggests the CLRG scheme based on the pixel brightness and the disparity. The cost function C(m, n) suggested according to the present invention is expressed as a following equation.

$$c ( m , n ) = {[ {( \frac{{S}_{k}}{{Size}_{k}} - I ( m , n ) )}^{2} + {a ( \frac{{T}_{k}}{{Size}_{k}} - d ( m , n ) )}^{2} ]}^{0.5}$$

In the above equation, Sₖ represents the sum of pixel values in a k^{th} region, Sizeₖ represents the size of the k^{th} region, and I(m, n) represents pixel brightness at the coordinates (m, n). In addition, a represents a proportional constant, Tₖ represents the sum of disparity values in the k^{th} region, and d(m, n) represents a disparity value at coordinates (m, n).

In addition, the left image is subject to the region division by taking into consideration the brightness and the disparity of a pixel as described above, and the result is shown in FIG. 9. Referring to FIG. 9, the edge of the table having disparity values that has been widely distributed is divided into small regions widthwise by taking into consideration the disparity values, and white lines shown in a lower portion of FIG. 9, that is, the leaf-shape prop is regarded as almost one region. Accordingly, only the leaf-shape prop can be easily extracted through the post treatment.

In addition, if the post treatment such as morphology filtering is performed after the left image has been subject to the region division, only an object (that is, a prop) having an excessive disparity can be extracted (S50), and the result is shown in FIG. 10. Referring to FIG. 10, only the prop having the excessive disparity may be separated and extracted. However, in the process of removing a protrusion by applying a morphology filter during the post treatment, a sharp edge of the prop may be partially smoothed.

As described above, according to the present invention, only the region (object) having the excessive disparity can be exactly separated. In particular, although region division is difficult when several objects having similar brightness are mixed in conventional region division only based on pixel brightness, region division according to the present invention can be easily and exactly performed by taking into consideration the disparity value together with the pixel brightness. In addition, if only the object having the excessive disparity is exactly separated as described above, only the object having the excessive disparity can be corrected in the subsequent process (depth tuning). Accordingly, 3-D images representing superior quality are formed so that a viewer can conveniently and safely view the 3-D images.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed.

### INDUSTRIAL APPLICABILITY

The present invention relates to a method of detecting an excessive disparity object, and can be extensively utilized in equipment or markets related to the 3-D images.

What is claimed is:

1. A method of detecting an excessive disparity object, the method comprising:
a disparity-map forming step of forming disparity-maps for left and right images by analyzing the left and right images included in a 3-D image;
a binarization step of setting an excessive disparity candidate region having a disparity value equal to or greater than a preset threshold value in each disparity-map;
a masking step of maintaining a pixel value of a region of one selected from the left and right images, which is overlapped with the excessive disparity candidate region, as an original pixel value, and substituting a pixel value of a region of the one selected from the left and right images, which is not overlapped with the excessive disparity candidate region, with a reference pixel value; and
a region division step of performing region division with respect to the region having the maintained pixel value based on pixel brightness and disparity.

2. The method of claim 1, wherein, in the region division step, the region division is performed through a centroid linkage region growing (CLRG) scheme.

3. The method of claim 2, wherein a cost function C(m,n) in the CLRG scheme is defined as following equation,
$$c ( m , n ) = {[ {( \frac{{S}_{k}}{{Size}_{k}} - I ( m , n ) )}^{2} + {a ( \frac{{T}_{k}}{{Size}_{k}} - d ( m , n ) )}^{2} ]}^{0.5} ,$$
in which Sₖ represents a sum of pixel values in a k^{th} region, Sizeₖ represents a size of the k^{th} region, I(m, n) represents pixel brightness at coordinates (m, n), a represents a proportional constant, Tₖ represents a sum of disparity values in the k^{th} region, and d(m, n) represents a disparity value at the coordinates (m, n).
